(19) United States
(12) Patent Application Publication
(10) Pub. No.: US 2026/0220809 A1
(43) Pub. Date: Jul. 30, 2026

(54) DEEP LEARNING BASED STATIC KEYPOINT DETECTION FOR VISUAL ODOMETRY

(71) Applicant: Torc Robotics, Inc., Blacksburg, AR (US)

(72) Inventors: Shile Li, Muenchen (DE); Fahim Mannan, Toronto (CA); Vicent Rodrigo Marco, Stuttgart (DE); Felix Heide, New York, NY (US)

(21) Appl. No.: 19/038,439

(22) Filed: Jan. 27, 2025

(51) Int. Cl. G06T 7/73; G06V 10/77; G06V 10/82; G06V 20/58

(52) U.S. Cl. CPC G06T 7/73; G06V 10/7715; G06V 10/82; G06V 20/58; G06T 2207/20081; G06T 2207/20084; G06T 2207/30252

(57) ABSTRACT

An autonomy computing system includes at least one memory configured to store machine executable instructions, and at least one processor configured to execute the machine executable instructions to implement a neural network configured to: (i) generate, based upon an image captured using an image sensor, a coordinate map, a feature map, and a score map to identify top-k keypoints satisfying a threshold score criterion for each of the coordinate map, the feature map, and the score map; (ii) based on the top-k keypoints corresponding to the coordinate map, the feature map, and the score map, identify coordinates, features, and scores of the top-k keypoints, respectively; and (iii) based upon the top-k keypoints identified for each of the coordinate map, the feature map, and the score map, identify top-k static keypoints for pose estimation while excluding other static and dynamic keypoints is disclosed.

### TECHNICAL FIELD

The field of the disclosure relates generally to visual odometry and, more specifically, determining a position and an orientation of an autonomous vehicle using deep learning based static keypoint detection.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

With respect to autonomous vehicle driving, estimating ego-motion (or how an autonomous vehicle perceives its own movement) is important for critical tasks such as motion control and trajectory planning. The ego-motion estimation is performed using visual odometry. In visual odometry, image streams captured using cameras (e.g., RGB cameras) are analyzed to extract keypoints and their associated descriptors for determining the autonomous vehicle's motion relative to the autonomous vehicle's environment. These descriptors facilitate matching between keypoints across frames, which subsequently enables precise pose optimization. The pose optimization is typically achieved through minimizing reprojection error, and effectively obtaining the ego-motion of the camera or vehicle over time as image streams captured using the cameras arrive.

However, one of the primary challenges in keypoint-based visual odometry is effective handling of dynamic objects. Dynamic objects are frequently encountered in real-world scenarios such as highway driving where an ego-vehicle is surrounded by multiple vehicles travelling at more or less similar speeds. The presence of dynamic objects violates the assumption underlying the optimization objective function, which assumes all associated keypoints to be static in the world coordinate system.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system including at least one memory configured to store machine executable instructions, and at least one processor coupled to the at least one memory is disclosed. The at least one processor is configured to execute the machine executable instructions to implement a neural network, wherein the neural network is configured to: (i) generate, based upon an image captured using an image sensor, a coordinate map; (ii) generate, based upon the image, a feature map; (iii) generate, based upon the image, a score map; (iv) based upon each of the coordinate map, the feature map, and the score map, identify top-k keypoints satisfying a threshold score criterion for each of the coordinate map, the feature map, and the score map; (v) identify, based on the top-k keypoints corresponding to the coordinate map, coordinates of the top-k keypoints identified of the coordinate map; (vi) identify, based on the top-k keypoints corresponding to the feature map, features of the top-k keypoints identified of the feature map; (vii) identify, based on the top-k keypoints corresponding to the score map, scores of the top-k keypoints identified of the score map; and (viii) based upon the top-k keypoints identified for each of the coordinate map, the feature map, and the score map, identify top-k static keypoints for pose estimation while excluding other static and dynamic keypoints.

In another aspect, a computer-implemented method performed using a neural network is disclosed. The computer-implemented method includes (i) generating, based upon an image captured using an image sensor, a coordinate map; (ii) generating, based upon the image, a feature map; (iii) generating, based upon the image, a score map; (iv) based upon each of the coordinate map, the feature map, and the score map, identifying top-k keypoints satisfying a threshold score criterion for each of the coordinate map, the feature map, and the score map; (v) identifying, based on the top-k keypoints corresponding to the coordinate map, coordinates of the top-k keypoints identified of the coordinate map; (vi) identifying, based on the top-k keypoints corresponding to the feature map, features of the top-k keypoints identified of the feature map; (vii) identifying, based on the top-k keypoints corresponding to the score map, scores of the top-k keypoints identified of the score map; and (viii) based upon the top-k keypoints identified for each of the coordinate map, the feature map, and the score map, identifying top-k static keypoints for pose estimation while excluding other static and dynamic keypoints.

In yet another aspect, a vehicle including an image sensor and at least one computing device is disclosed. The at least one computing device includes at least one memory configured to store machine executable instructions, and at least one processor coupled to the at least one memory. The at least one processor is configured to execute the machine executable instructions to implement a neural network. The neural network is configured to: (i) generate, based upon an image captured using the image sensor, a coordinate map; (ii) generate, based upon the image, a feature map; (iii) generate, based upon the image, a score map; (iv) based upon each of the coordinate map, the feature map, and the score map, identify top-k keypoints satisfying a threshold score criterion for each of the coordinate map, the feature map, and the score map; (v) identify, based on the top-k keypoints corresponding to the coordinate map, coordinates of the top-k keypoints identified of the coordinate map; (vi) identify, based on the top-k keypoints corresponding to the feature map, features of the top-k keypoints identified of the feature map; (vii) identify, based on the top-k keypoints corresponding to the score map, scores of the top-k keypoints identified of the score map; and (viii) based upon the top-k keypoints identified for each of the coordinate map, the feature map, and the score map, identify top-k static keypoints for pose estimation while excluding other static and dynamic keypoints.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 illustrates an example diagram of a unified, efficient neural network that produces static keypoints along with their descriptors or scores in a single stage for generating static keypoints;

FIG. 5 illustrates a block diagram of the unified, efficient neural network shown in FIG. 4;

FIG. 6 illustrates a block diagram of a keypoint network of the unified, efficient neural network shown in FIG. 4;

FIG. 7A illustrates a coordinate head of the keypoint network shown in FIG. 6;

FIG. 7B illustrates a feature head of the keypoint network shown in FIG. 6;

FIG. 7C illustrates a score head of the keypoint network shown in FIG. 6; and

FIG. 8 is a flow diagram of an embodiment method of static keypoints detection.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Mission control: Mission control, as described in the present disclosure, refers to one or more application servers, and one or more database servers communicatively coupled with each other and one or more autonomous vehicles of a fleet. Mission control receives sensor data collected by one or more sensors of the one or more autonomous vehicles of the fleet and transmit data including, but not limited to, trajectory data, described herein, to the one or more autonomous vehicles of the fleet.

Visual Odometry: Visual odometry is a computer vision technique that uses a camera's images to estimate the position and movement of a vehicle (e.g., an autonomous vehicle). Visual odometry can be used in a variety of applications including, but not limited to, in autonomous vehicle navigation systems. Visual odometry is based upon tracking features in a sequence of a plurality of images and using those tracked features to estimate the camera's (or the autonomous vehicle's) motion between frames.

The disclosed systems and methods address the primary challenges in keypoint-based visual odometry for autonomous vehicles. As described herein, one of the primary challenges in keypoint-based visual odometry is effective handling of dynamic objects that are frequently encountered in real-world scenarios such as highway driving. While an ego-vehicle is driving on a highway, the ego-vehicle is generally surrounded by multiple vehicles travelling at more or less similar speeds. The presence of dynamic objects violates a basic assumption made for an optimization objective function. Generally, the optimization objective function is based on an assumption that all associated keypoints in the world coordinate system are static. Certain embodiments of the disclosed systems and methods exclude dynamic keypoints to ensure stability and accuracy of visual odometry results. Certain embodiments produce robust static keypoints along with their descriptors/scores that avoids keypoint detection on dynamic object using a unified, light-weight neural network. Accordingly, the disclosed systems and methods avoid keypoint detection on dynamic objects using the neural network improves on conventional methods for avoiding keypoints detection on dynamic objects such as, e.g., a filtering-based method or a semantic segmentation-based method.

Filtering-based methods generally use a random sample consensus (RANSAC) algorithm or a robust weight estimation algorithm to find the largest consensus pattern of static keypoints following the same rigid motion pattern. However, the filtering-based method could fail if dynamic keypoints dominate the observed environment. Further, the RANSAC algorithm could be hijacked by dynamic objects, for example, by mistakenly treating dynamic keypoints as static keypoints. Other filtering-based methods that use robust weight estimation algorithm also have the same issue when dynamic keypoints dominate the environment surrounding the ego-vehicle. Further, the filtering-based methods lack the capability to handle high dynamic scenarios in which dynamic keypoints dominate over static keypoints due to requiring a comparatively large number of frames to detect regions of dynamic keypoints.

Currently known semantic segmentation-based methods employ neural network-based models to discern dynamic elements within image data. These neural network-based models are trained to recognize dynamic pixels in the image, allowing for their exclusion from the odometry process. However, these neural network-based segmentation networks are computationally intense and add a large amount of extra cost to a visual odometry pipeline, and the performance is dependent on the segmentation quality.

Additionally, conventional filtering-based methods or semantic segmentation-based methods are an extra activity that needs to be performed in addition to a keypoint detection process.

The disclosed embodiments provide a unified keypoint detection framework that extracts keypoints in a way that is efficient in computing, robustly identifies static keypoints, and benefits pose optimization.

Compared to currently known methods requiring two stage computation, a method disclosed herein according to some embodiments provides a unified, efficient neural network that produces static keypoints along with their descriptors/scores in a single stage for generating static keypoints. In some embodiments, the neural network takes RGB images as input, with dimensions (3, H, W), where H and W represent the height and width of the image, respectively, and 3 denotes the RGB channels, for example, red, green, and blue channels. The direct outputs of the neural network consist of three maps, for example, a coordinate map (2, H//8, W//8), a feature map (32, H//8, W//8), and a score map (1, H//8, W//8). Each of the three maps has a downsampled size of H//8 and W//8, as represented by the second and third field in the parenthesis. The first field in the parenthesis represents dimensions of the map. Accordingly, the coordinate map, the feature map, and the score map have 2 dimensions, 32 dimensions, and one dimension, respectively, in one example.

The coordinate map indicates coordinates of each keypoint on the original RGB image, representing the x- and y-axes of the image pixel coordinates. The feature map signifies keypoint features associated with each keypoint. The keypoint features of an image are distinct, identifiable features like corners, edges, or areas of high contrast, allowing for object recognition and matching even when the image is scaled, rotated, or slightly distorted. Accordingly, using the keypoint features, keypoints in an image can be described and compared with different images of the same scene or object. The score map determines an importance of each keypoint for pose optimization. The determined importance of each keypoint using the score map is used to select top-k keypoints and filter out low-score keypoints. In other words, during post processing of the coordinate map, the feature map, and the score map, keypoints having low score values are filtered out and remaining (or not filtered out) keypoints are used to select top-k keypoints as the final outputs of the keypoint detection module for each of the coordinate map, the feature map, and the score map.

In some embodiments, the neural network may be a feature estimation backbone neural network, for example, a convolutional neural network (CNN) or a residual neural network such as ResNet18, may spatially downsample the input images to obtain spatially downsampled dense feature vectors having, for example, 512 dimensions, a height of H//8, and a width of W//8. From the spatially downsampled dense feature vectors, the coordinate map, the feature map, and the score map, are obtained using a coordinate head, a feature head, and a score head, respectively. The coordinate head, the feature head, and the score head are last parts or output layers of the neural network. Each of the coordinate head and the feature head may have a single branch of CNN, and the score head may have three different CNN branches. Each CNN branch of the score head may produce a different score map. For example, a first CNN branch may generate a repeatability score map S1, a second CNN branch may generate an importance score map S2, and a third CNN branch may generate a static score map S3. S1, S2, and S3 each may have a single dimension, a height of H//8, and a width of W//8. Each the S1, S2, and S3 may be combined to generate an element-wise product that is a final score map S also having a single dimension, a height of H//8, and a width of W//8. From the score map S, top k keypoints are selected. The value of k may range from 100-1000 with 700 being a reasonable choice. The value of k is selected based upon an image resolution. The value of k, as specified herein, is based upon an image resolution of 960×544. The top-k static keypoints with their respective coordinate and features may thus identified eliminating dynamic keypoints.

Accordingly, one of the primary challenges in keypoint-based visual odometry associated with handling of dynamic objects is solved by eliminating dynamic keypoints, using embodiments as described herein. Further, while training the score map, different types of losses can occur that make the training highly unstable and prevent its convergence. However, in the described embodiments, three different score maps are produced or generated, and different type of losses, for example, pose estimation loss, dynamic region penalization loss, and self-supervision loss, are applied to each of them, as described in detail below, to generate the final score map S. Various test experiments performed using the described embodiments show significant improvement in comparison with Oriented FAST and Rotated BRIEF (ORB) keypoints detection technique by suppressing dynamic vehicles ensuring robust visual odometry in highly dynamic cases.

In example embodiments, pose estimation loss L_pose is applied to stereo pairs, for example, left and right images <l1,r1> and <l2,r2> at different times, e.g., times t1 and t2. Using differentiable optimization to minimize the keypoint reprojection residuals, the relative pose between time t1 and t2 is computed. The pose estimation loss L_pose encourages detection of high-quality keypoints by assigning higher scores to accurate keypoints that contribute to precise pose estimation, while penalizing poor keypoints with lower score values. The pose estimation loss L_pose ensures detection of reliable keypoints for accurate pose estimation. An input dataset for determining the pose estimation loss L_pose includes sequences of stereo images. A single input data sample for the pose estimation branch includes RGB images of a stereo pair, camera intrinsics and extrinsics, as well as the left camera's pose in local coordinate (local coordinate used as convention as in ppk ground-truth, the starting location of the driving with NED rotation frame).

Preprocessing for the pose estimation loss L_pose computation includes selecting pairs of frames that meet certain criteria for proximity, minimum separation, and time difference. In particular, frames may be selected to ensure enough overlapping visible area to accurately estimate the relative pose. Accordingly, the selected frames are, for example, within 7 meters of each other but at least 0.5 meters apart, to avoid oversampling while the ego-vehicle is standstill. Additionally, the frames are selected such that the relative time difference between them is, for example, less than 2 minutes. Accordingly, selected pairs of frames are close enough to provide sufficient overlap for pose estimation, yet distinct enough to avoid redundant data from stationary periods. Additionally, ensuring a reasonable time gap prevents inaccuracies due to significant temporal changes.

Additionally, standard color augmentation is performed on the left and right images of the stereo pairs. The standard color augmentation includes adjustments such as random hue jittering, adding Gaussian noise, converting to grayscale, adjusting contrast, modifying brightness, and applying a median filter. Each of these augmentations is applied with a predefined probability to enhance the variability and robustness of the training dataset. Image rectification of the input stereo images may also be performed if the input stereo images are unrectified. Image rectification may be performed to correct the distortion in the images, to align them on a common image plane, generate the rectified images and a new camera matrix after rectification, and adjust the camera poses to correspond to the rectified images.

Stereo images at times t1 and t2 are fed as inputs to the keypoint network, such as the feature estimation backbone neural network described above, for computing pose estimation and outputting the score map for pose estimation. In particular, four sets of keypoints, features, and scores are obtained by feeding stereo images at times t1 and t2 (left and right images at time t1 and left and right images at time t2) into the keypoint network. Using the obtained sets of keypoints, keypoints for the left and right images at time t1 are associated and keypoints for the left and right images at time t2 are associated using their respective feature vectors, and 3D points are obtained corresponding to t1 and t2 by triangulation. The 3D points from t1 are associated with the 3D points from t2 in each left image and each right image. A window-bounded search with predicted relative pose reprojection may be used to find the nearest neighbor in feature space.

Using the relative pose parameters on both the left and right image at t2, the pose optimization process to project 3D points is performed. By way of an example, the pose optimization process includes defining robust residuals of reprojection on both left and right images at t2. Each residual is weighted based on the score values Sₜ₁ and Sₜ₂. The relative pose parameters are optimized using Eq. 1 below.

$$Residual = {\sum }_{i} ( {s}_{t 1} + {s}_{t 2} ) ρ ( {‖ π ( {T}_{t 1}^{t 2} , {P}_{\dot{l}} ) - {c}_{t 2} ‖}^{2} ) \qquad Eq . 1$$

In Eq. 1 above, ρ( ) is the robust loss function, π( ) is the projection function using the relative pose parameters

$${T}_{t 1}^{t 2} ,$$

Pₗ are 3D points, and cₜ₂ are we corresponding keypoint coordinate in frames at time t2. The final estimated pose would be then as shown in Eq. 2. Note that in the Eq. 2, the subscripts for the left/right cameras in t2 are omitted. However, in the actual implementation, both the left and right cameras of t2 are considered.

$${T}_{opt} = arg {min}_{T} {\sum }_{i} ρ ( {‖ π ( T , {P}_{\dot{l}} ) - {c}_{t 2} ‖}^{2} ) \qquad Eq . 2$$

The estimated pose value Tₒₚₜ is compared against the ground-truth relative pose to compute the loss for training using Eq. 3 below in which T_{gt} is ground-truth relative pose.

$${l}_{p o s e} = {‖ {T}_{opt} - {T}_{gt} ‖}^{2} \qquad Eq . 3$$

In example embodiments, dynamic region penalization loss may be applied, for example, for training of the dynamic segmentation branch in the score head, to obtain the static score heatmap with high values for static elements or objects in the world (or surrounding the ego vehicle) and very low or near-zero values for dynamic elements or objects. Accordingly, it can be ensured that only static keypoints are selected in the downstream top-k selection. In the present disclosure, “static” and “dynamic” keypoints refer to semantically static and semantically dynamic elements, respectively. By way of an example, a keypoint corresponding to a parked vehicle is considered a dynamic keypoint instead of a static keypoint because the parked vehicle could potentially move.

The raw data sample may include both RGB images and semantic segmentation labels. The labels may be, for example, according to the KITTI convention, and encompassing 16 different classes such as road, tree, car, pedestrian, etc., with the same image shape as the RGB image, allowing for pixel-wise labeling. During a preprocessing step, the input data of the RGB images may be augmented to enrich the dataset to mitigate the high cost of obtaining semantically labeled data. During the preprocessing step, one or more of brightness, contrasts, saturation, and hue of the RGB images may be adjusted by performing color augmentation to create variations in the dataset. Further, random warping is applied to both the RGB images and mask images. The random warping is crucial to ensure that the trained machine learning model is robust to geometric transformations. Even though the random warping is applied, the exact same warping is applied to both the RGB image and a binary staticness mask to maintain consistency. The binary staticness mask is generated by converting the semantic map into the binary staticness mask that labels classes such as vehicles or pedestrians, or both, as dynamic objects (zeros) while other classes as static objects (ones). The conversion, as described herein, helps to create the learning target the focus on distinguishing between dynamic objects (or elements) and static objects (or elements). Additionally, the mask image is resized to the ⅛th of the original image size, for example, to be compatible with the shape of the output score map. By incorporating these preprocessing and data augmentation steps, the robustness and generalization capabilities of a machine learning model is enhanced while making efficient use of the available labeled data.

The loss computation in this branch focuses on training the static score map in the score head. In this case, the predicted score map is compared against the ground truth mask to compute the loss between the prediction (score_pred) and ground truth (mask_gt), using Eq. 4 below.

$$diff = ( score\_pred - mask\_gt ) . square ( ) \qquad Eq . 4$$

Furthermore, since the number of pixels for the static environment significantly outnumbers those for dynamic objects, the class distribution's influence on the training is balanced using class-balanced loss computation using Eq. 5.

$$dyn\_loss = ( diff * mask\_gt ) . sum ( ) / mask\_gt . sum ( ) + ( diff * ( 1 - mask\_gt ) ) . sum ( ) / ( 1 - mask\_gt ) . sum ( ) \qquad Eq . 5$$

Accordingly, both dynamic and static regions are weighted appropriately during training, helping to improve the machine learning model's performance in detecting dynamic objects while maintaining accuracy in static areas.

In example embodiments, self-supervision loss utilizes color-augmented and perspective-warped images to simulate variations in viewpoint and conditions within the same scene. This process encourages the model to identify consistent keypoints across different perspectives. Specifically, the self-supervision loss ensures that corresponding keypoints in both the original and warped images obtain similar feature representations and scores. This approach enhances the robustness of keypoint detection by leveraging augmented images to train the model in recognizing pose or illumination invariant keypoint and their features.

The input data sample for self-supervision branch may be just a single RGB image with shape of H and W and having three channels. Using an input image im, random image warping is performed to create a warped image. During this process, the randomly generated perspective warping transform matrix M are stored using Eq. 6 below.

$$M = gen\_random \_warping ( H , W ) \qquad Eq . 6$$

$$im\_warped = Warp\_image ( im , M ) \qquad Eq . 7$$

The warping function Warp_image(x, M) maps the pixel coordinates x=[u,v] from the original image to the pixel coordinates in the warped image with coordinate mapping function W as shown in Eq. 8 below.

$${x}^{′} = W ( x ) \qquad Eq . 8$$

After obtaining the warped image, random color jittering is performed on both the original image and the warped image. The color jittering process includes hue jittering, Gaussian noise, grayscaling the image, contrast jittering, brightness jittering, and medial filter, each occurring with a predefined probability.

In example embodiments, the color augmentation for the images is applied as follows:

$$im = color\_augment ( im ) \qquad Eq . 9$$

$$im\_warped = color\_augment ( im\_warm ) \qquad Eq . 10$$

After the preprocessing step, the data sample is fed into the neural network as input would be the original image im and the warped image im_warped as well as the warping transform matrix M, where im and im_warped are having 3 dimensions, height H, and width W. The transform matrix M is [3, 3]. Both the original image and the warped image are processed by the same keypoint network, which generates coordinate, feature, and score maps (c,f,s) for the original image and (c′,f′,s′) for the warped image. Using the ground-truth warping matrix generated during preprocessing, we can compute the self-supervision loss, which consists of three different types of losses.

$${L}_{selfsup} = {L}_{triplet +} {L}_{score +} {L}_{p o sition} \qquad Eq . 11$$

In Eq. 11 above, the first type of loss is the feature triplet loss (Lₜᵣᵢₚₗₑₜ) that ensures that features computed on both the original and warped images, which represent the same object in the scene, have similar feature vectors and feature vectors representing different objects in the scene are dissimilar. From the original image, keypoint features at coordinates c from the feature map f are extracted resulting in

$${f}_{i}^{c}$$

where i=1, 2, 3, . . . , N. The detected keypoint coordinates c from the original image are warped to the warped image, and the corresponding features from the feature map f′ are extracted, which results in

$${{f}_{i}^{′}}^{cwarped}$$

where i=1, 2, 3, . . . , N. The triplet loss is formulated to ensure that the feature vector for a keypoint in the original image is close to the feature vector for the corresponding keypoint in the warped image (positive pair) and far from the feature vectors of different objects (negative pairs).

Let

$${f}_{i}^{c}$$

$$and$$

$${{f}_{i}^{′}}^{cwarped}$$

represent the feature vectors of the i-th keypoint in the original and warped images, respectively, and let

$${f}_{j}^{′}$$

represent the feature vector of a different object that results in the smallest (hardest) distance, then the triplet loss can be formulated as Eq. 12 below.

$${L}_{triplet} = {\sum }_{i} max ( 0 , \vert \vert {f}_{i}^{c} - {{f}_{i}^{′}}^{cwarped} \vert \vert - \vert \vert {f}_{i}^{c} - {f}_{j}^{′} \vert \vert + m ) \qquad Eq . 12$$

In Eq. 12, j indicates the hardest negative sample's index, and m is the margin value used for triplet loss.

Further, the score loss (L_{score}) ensures two key objectives including self-supervision consistency (e.g., the same keypoint in both the original and warped images having similar score values) and distance-based score adjustment in which keypoints with smaller distances between each other (in pixel space) are given or assigned a higher score value, and keypoints with larger distances are given or assigned a smaller score value. Accordingly, the score loss is formulated as Eq. 13 below.

$${L}_{s c o r e} = {\sum }_{i} ( {S}_{i} + {S}_{i}^{′} ) ( ‖ {C}_{i} - {C}_{i}^{′} ‖ - \overline{d} ) + {( {S}_{i} - {S}_{i}^{′} )}^{2} \qquad Eq . 13$$

In Eq. 13 above,

$$\overline{d} = \frac{{\sum }_{i} ‖ Ci - {C}_{i}^{′} ‖}{L}$$

represents the mean value of the keypoint distance in pixel space,

$${C}_{i}^{′}$$

is the nearest detected keypoint on the warped image after applying the known perspective transform to the original keypoint Ci and

$${S}_{i}^{′}$$

is the associated score value.

Accordingly, by minimizing this loss objective, pairs with a larger distance than the mean are penalized with a smaller score, while pairs with a smaller keypoint distance than the mean are encouraged with a larger score value.

Further, the keypoint position loss ensures that detected keypoints on both the original and warped images appear at the exact same fine-grained pixel locations representing the same object in the scene. This is achieved by minimizing the Euclidean distance between Ci and

$${C}_{i}^{′} ,$$

where

$${C}_{i}^{′}$$

is the nearest detected keypoint in the warped image after warping.

The position loss Lₚₒₛᵢₜᵢₒₙ is computed using Eq. 14 below.

$${L}_{position} = {\sum }_{i} {‖ {C}_{i} - {C}_{i}^{′} ‖}^{2} \qquad Eq . 14$$

In Eq. 14 above, Cᵢ represents the coordinates of the keypoint in the original image, and

$${C}_{i}^{′}$$

represents the corresponding keypoint coordinates in the warped image. By minimizing this loss, the network ensures that keypoints detected in both images align precisely.

Various embodiments are described with reference to relevant drawings.

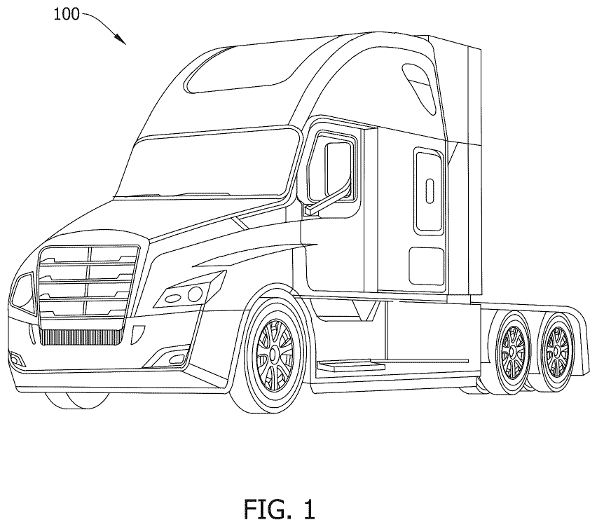

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

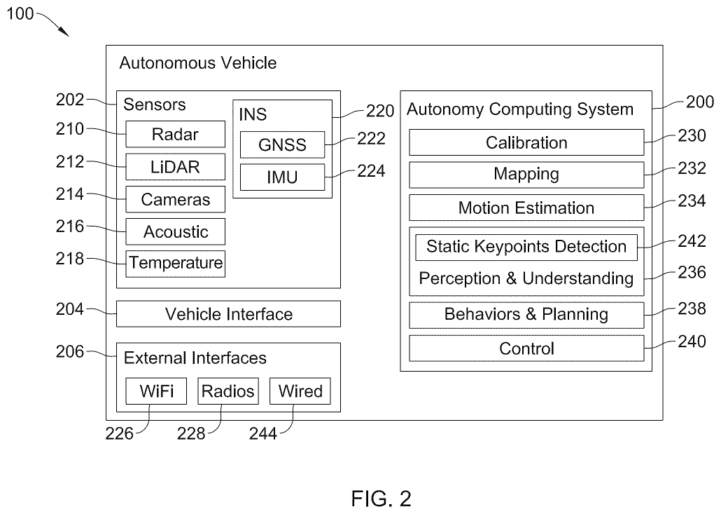

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a static keypoints detection module 242. The static keypoints detection module 242, for example, may be embodied within another module, such as perception and understanding module 236, behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100. The static keypoints detection module 242 is configured to efficiently and robustly identify and extract static keypoints as described in detail in the present disclosure.

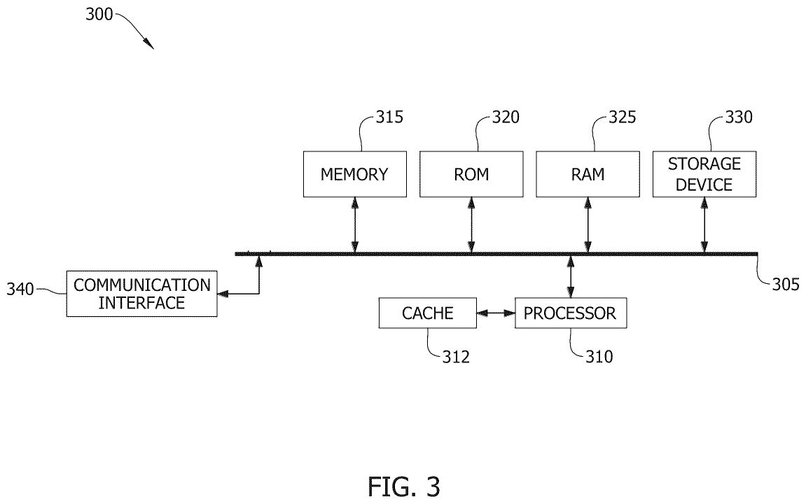

FIG. 3 illustrates an example computing system 300 that can implement various techniques, processes, functions, or methods described herein. Computing system 300 may be embodied within, for example, autonomous vehicle 100 shown in FIG. 1, such as autonomy computing system 200 shown in FIG. 2. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, to processor 310.

The processor 310 may be communicatively coupled with a communication interface 340 to communicate with external entities such as, mission control, or one or more other vehicles using V2V communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; and (iv) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

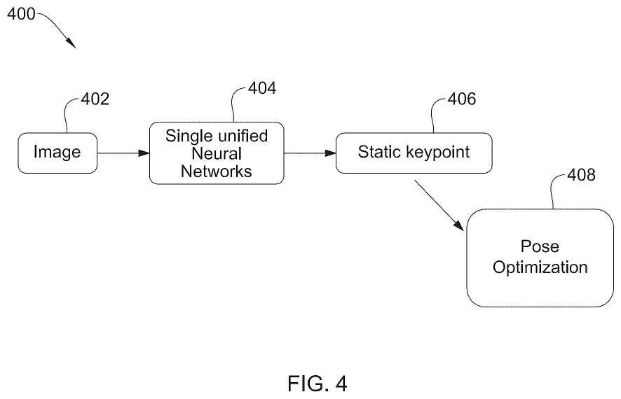

FIG. 4 illustrates an example diagram 400 of a unified, efficient neural network 404 that produces static keypoints 406 along with their descriptors or scores in a single stage for generating static keypoints 406. In some embodiments, the neural network 404 takes RGB images as input 402. Each of the RGB images 402 may have dimensions (3, H, W), where H and W represent the height and width of the image, respectively, and 3 denotes the RGB channels, for example, red, green, and blue channels, and may generate pose optimization 408 as an output.

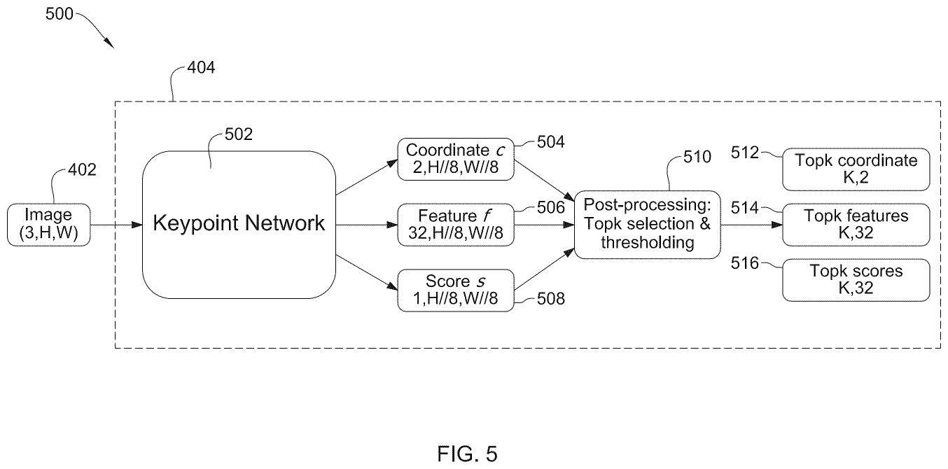

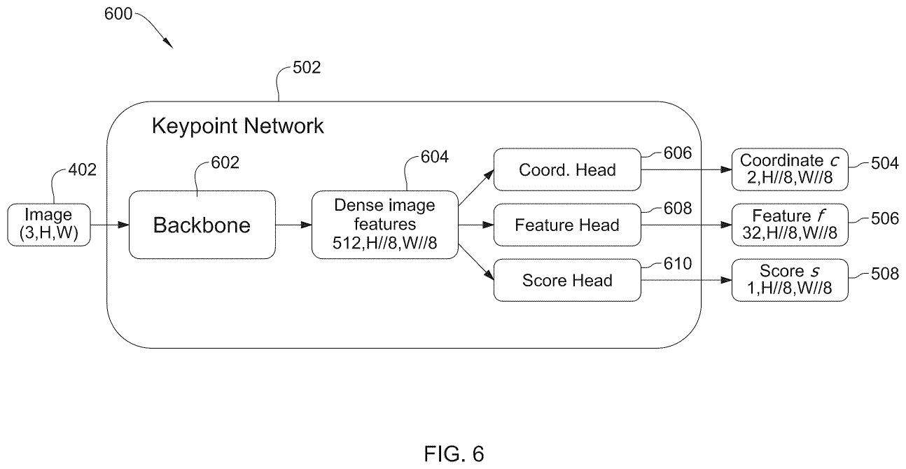

FIG. 5 illustrates a block diagram 500 of the unified, efficient neural network 404. As shown in FIG. 5, the unified, efficient neural network 404 includes a keypoint network 502 that is further explained using FIG. 6. The keypoint network 502 takes RGB images 402 as input and generate three maps, for example, a coordinate map (2, H//8, W//8) 504, a feature map (32, H//8, W//8) 506, and a score map (1, H//8, W//8) 508. Each of the three maps 504, 506, and 508 has a downsampled size of H//8 and W//8, as represented by the second and third field in the parenthesis. The first field in the parenthesis represents dimensions of the map. Accordingly, the coordinate map 504, the feature map 506, and the score map 508 have 2 dimensions, 32 dimensions, and one dimension, respectively, in one example.

The coordinate map 504 indicates coordinates of each keypoint on the original RGB image 402, representing the x- and y-axes of the image pixel coordinates. The feature map 506 signifies keypoint features associated with each keypoint. The keypoint features of an image are distinct, identifiable features like corners, edges, or areas of high contrast, allowing for object recognition and matching even when the image is scaled, rotated, or slightly distorted. Accordingly, using the keypoint features, keypoints in an image can be described and compared with different images of the same scene or object. The score map 508 determines an importance of each keypoint for pose optimization 408. The determined importance of each keypoint using the score map 508 is used to select top-k keypoints and filter out low-score keypoints. In other words, during post processing 510 of the coordinate map 504, the feature map 506, and the score map 508, keypoints having low score values are filtered out and remaining (or not filtered out) keypoints are used to select top-k keypoints 512, 514, and 516, as the final outputs of the keypoint detection module for each of the coordinate map 504, the feature map 506, and the score map 508, respectively.

In some embodiments, the neural network 404 or the keypoint network 502 may be a feature estimation backbone neural network shown in FIG. 6 as 602. The feature estimation backbone neural network 602 in the example diagram 600 of FIG. 6 may be a convolutional neural network (CNN) or a residual neural network such as ResNet18, The feature estimation backbone neural network 602 may spatially downsample the input images 402 to obtain spatially downsampled dense feature vectors 604 having, for example, 512 dimensions, a height of H//8, and a width of W//8. From the spatially downsampled dense feature vectors 604, the coordinate map 504, the feature map 506, and the score map 508, are obtained using a coordinate head 606, a feature head 608, and a score head 610, respectively. The coordinate head 606, the feature head 608, and the score head 610 are last components or output layers of the neural network 602.

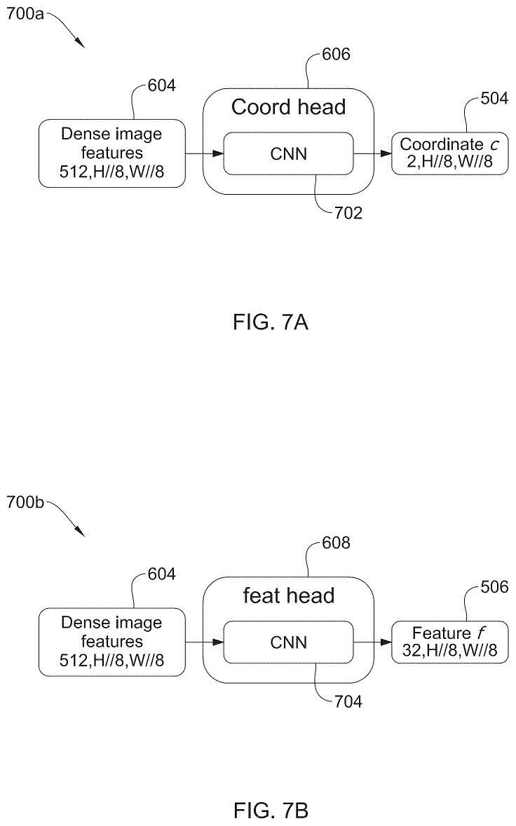

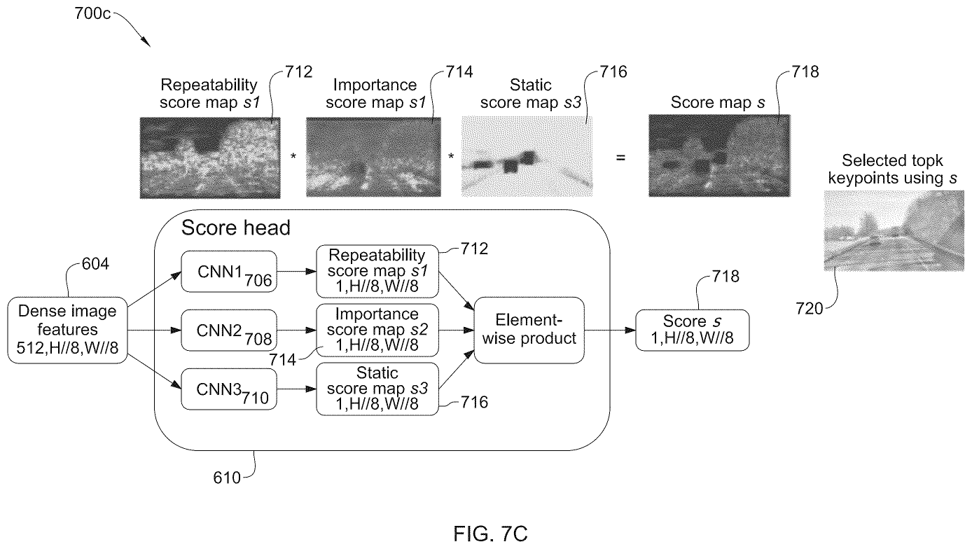

As shown in an example diagram 700a of FIG. 7A, the coordinate head 606 has a single branch of CNN 702. Further, as shown in an example diagram 700b of FIG. 7B, the feature head 608 has a single branch of CNN 704. As shown in an example diagram 700c of FIG. 7C, the score head 610 has three different CNN branches 706, 708, and 710. Each CNN branch of the CNN branches 706, 708, and 710, the score head 610 may produce a different score map. For example, a first CNN branch 706 may generate a repeatability score map S1 712, a second CNN branch 708 may generate an importance score map S2 714, and a third CNN branch 710 may generate a static score map S3 716. S1 712, S2 714, and S3 716 each may have a single dimension, a height of H//8, and a width of W//8. Each the S1 712, S2 714, and S3 716 may be combined to generate an element-wise product that is a final score map S 718. The final score map S 718 also has a single dimension, a height of H//8, and a width of W//8. From the final score map S 718, top k keypoints are selected as shown in FIG. 7C by 720. As described herein, the value of k may range from 100-1000 with 700 being a reasonable choice. The value of k is selected based upon an image resolution. The value of k, as specified herein, is based upon an image resolution of 960×544. The top-k static keypoints with their respective coordinate and features may thus be identified eliminating dynamic keypoints.

Accordingly, one of the primary challenges in keypoint-based visual odometry associated with handling of dynamic objects is solved by eliminating dynamic keypoints, using embodiments as described herein. Further, while training the score map, different types of losses can occur that make the training highly unstable and prevent its convergence. However, in the described embodiments, three different score maps are produced or generated, and different type of losses, for example, pose estimation loss, dynamic region penalization loss, and self-supervision loss, are applied to each of them, as described in the present disclosure above, to generate the final score map S 718.

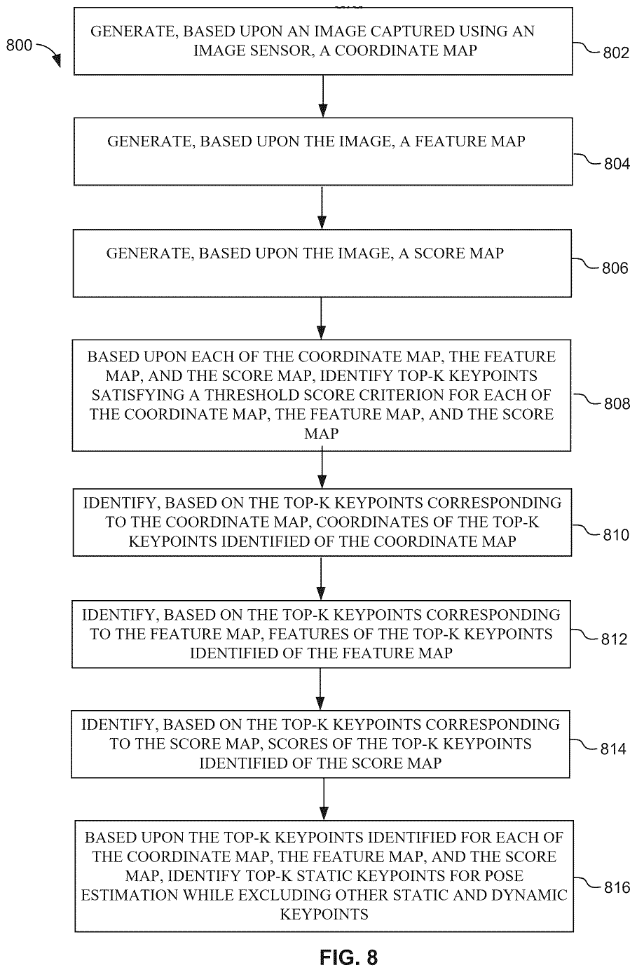

FIG. 8 is a flow chart of an example embodiment of a method 800 of static keypoints detection. The method 800 may be embodied in autonomy computing system 200 or, more specifically, the static keypoints detection module 242 (shown in FIG. 2), or processor 310 (shown in FIG. 3). The method 800 is performed by a neural network, and the method 800 includes generating 802, based upon an image, a coordinate map. The image is captured using an image sensor such as an image sensor 214 shown in FIG. 2. The generated coordinate map indicates coordinates of the keypoints of the image. The coordinate map includes x and y coordinates of each keypoint of the keypoints and has a downsampled height and a downsampled width in comparison to the image.

The method 800 includes generating 804, based upon the image, a feature map. The generated feature map indicates features of the keypoints of the image. The feature map includes 32 dimensions of each keypoint of the keypoints, and has a downsampled height and a downsampled width in comparison to the image. The method 800 includes generating 806, based upon the image, a score map. The score map indicates importance of the keypoints of the image. The score map includes one dimension for each keypoint of the keypoints, and has a downsampled height and a downsampled width in comparison to each of the image.

The method 800 includes identifying 808 top-k keypoints satisfying a threshold score criterion for each of the coordinate map, the feature map, and the score map, and based upon the top-k keypoints corresponding to the coordinate map, identifying 810 coordinates of the top-k keypoints identified of the coordinate map. The method 800 includes identifying 812, based on the top-k keypoints corresponding to the feature map, features of the top-k keypoints identified of the feature map. The threshold score is determined through visual inspection and set empirically based on score heatmap visualizations. Keypoints are selected to prioritize static elements in the scene. The threshold score ranges from 0 and 1, and for day scenes, a threshold of 0.4 is typically used, while a threshold of 0.2 is generally used for night scenes. The method 800 also includes identifying 814, based on the top-k keypoints corresponding to the score map, scores of the top-k keypoints identified of the score map. The method 800 also includes, based upon the top-k keypoints identified for each of the coordinate map, the feature map, and the score map, identifying 816 top-k static keypoints for pose estimation while excluding other static and dynamic keypoints, as described herein.

The neural network performing the method 800 may be a residual neural network such as ResNet18. The neural network is configured to generate dense image features of 512 dimensions and having a downsampled height and a downsampled width in comparison to the image. Further, the coordinate map is generated from the dense image features using a coordinate head including a convolution neural network (CNN) or a first CNN, and the feature map is generated from the dense image features using a feature head including another CNN or a second CNN, as described herein. The neural network may be further configured to compute a self-supervision loss, a pose estimation loss, and a dynamic region penalization loss for the image.

The score map is generated from the dense image features using a score head including three different CNNs. A first of the three different CNNs is configured to generate a repeatability score map, a second of the three different CNNs is configured to generate an importance score map, and a third of the three different CNNs is configured to generate a static score map.

An example technical effect of the methods, systems, and apparatus described herein includes at least a unified keypoint detection framework that extracts keypoints in a way that is efficient in computing, and robustly identifies static keypoints, and benefits pose optimization.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. An autonomy computing system comprising:
at least one memory configured to store machine executable instructions; and
at least one processor coupled to the at least one memory and configured to execute the machine executable instructions to implement a neural network, wherein the neural network is configured to:
generate, based upon an image captured using an image sensor, a coordinate map;
generate, based upon the image, a feature map;
generate, based upon the image, a score map;
based upon each of the coordinate map, the feature map, and the score map, identify top-k keypoints satisfying a threshold score criterion for each of the coordinate map, the feature map, and the score map;
identify, based on the top-k keypoints corresponding to the coordinate map, coordinates of the top-k keypoints identified of the coordinate map;
identify, based on the top-k keypoints corresponding to the feature map, features of the top-k keypoints identified of the feature map;
identify, based on the top-k keypoints corresponding to the score map, scores of the top-k keypoints identified of the score map; and
based upon the top-k keypoints identified for each of the coordinate map, the feature map, and the score map, identify top-k static keypoints for pose estimation while excluding other static and dynamic keypoints.

2. The autonomy computing system of claim 1, wherein the coordinate map indicates coordinates of the keypoints of the image, wherein the coordinate map includes x and y coordinates of each keypoint of the keypoints, and wherein the coordinate map has a downsampled height and a downsampled width in comparison to the image.

3. The autonomy computing system of claim 1, wherein the feature map indicates features of the keypoints of the image, wherein the feature map includes 32 dimensions of each keypoint of the keypoints, and wherein the feature map has a downsampled height and a downsampled width in comparison to the image.

4. The autonomy computing system of claim 1, wherein the score map indicates importance of the keypoints of the image, wherein the score map includes one dimension for each keypoint of the keypoints, and wherein the score map has a downsampled height and a downsampled width in comparison to the image.

5. The autonomy computing system of claim 1, wherein the neural network is a residual neural network such as ResNet18 and configured to generate dense image features of 512 dimensions and having a downsampled height and a downsampled width in comparison to the image.

6. The autonomy computing system of claim 5, wherein the coordinate map is generated from the dense image features using a coordinate head including a convolution neural network (CNN).

7. The autonomy computing system of claim 5, wherein the feature map is generated from the dense image features using a feature head including a convolution neural network (CNN).

8. The autonomy computing system of claim 5, wherein the score map is generated from the dense image features using a score head including three different convolution neural networks (CNNs), a first of the three different CNNs configured to generate a repeatability score map, a second of the three different CNNs configured to generate an importance score map, and a third of the three different CNNs configured to generate a static score map.

9. The autonomy computing system of claim 1, wherein the neural network is further configured to compute a self-supervision loss, a pose estimation loss, and a dynamic region penalization loss for the image, and wherein k is selected based upon an image resolution.

10. A computer-implemented method performed using a neural network, the computer-implemented method comprising:
generating, based upon an image captured using an image sensor, a coordinate map;
generating, based upon the image, a feature map;
generating, based upon the image, a score map;
based upon each of the coordinate map, the feature map, and the score map, identifying top-k keypoints satisfying a threshold score criterion for each of the coordinate map, the feature map, and the score map;
identifying, based on the top-k keypoints corresponding to the coordinate map, coordinates of the top-k keypoints identified of the coordinate map;
identifying, based on the top-k keypoints corresponding to the feature map, features of the top-k keypoints identified of the feature map;
identifying, based on the top-k keypoints corresponding to the score map, scores of the top-k keypoints identified of the score map; and
based upon the top-k keypoints identified for each of the coordinate map, the feature map, and the score map, identifying top-k static keypoints for pose estimation while excluding other static and dynamic keypoints.

11. The computer-implemented method of claim 10, wherein the coordinate map indicates coordinates of the keypoints of the image, wherein the coordinate map includes x and y coordinates of each keypoint of the keypoints, and wherein the coordinate map has a downsampled height and a downsampled width in comparison to the image.

12. The computer-implemented method of claim 10, wherein the feature map indicates features of the keypoints of the image, wherein the feature map includes 32 dimensions of each keypoint of the keypoints, and wherein the feature map has a downsampled height and a downsampled width in comparison to the image.

13. The computer-implemented method of claim 10, wherein the score map indicates importance of the keypoints of the image, wherein the score map includes one dimension for each keypoint of the keypoints, and wherein the score map has a downsampled height and a downsampled width in comparison to the image.

14. The computer-implemented method of claim 10, wherein the neural network is a residual neural network such as ResNet18 and configured to generate dense image features of 512 dimensions and having a downsampled height and a downsampled width in comparison to the image.

15. The computer-implemented method of claim 14, wherein the coordinate map is generated from the dense image features using a coordinate head including a convolution neural network (CNN).

16. The computer-implemented method of claim 14, wherein the feature map is generated from the dense image features using a feature head including a convolution neural network (CNN).

17. The computer-implemented method of claim 14, wherein the score map is generated from the dense image features using a score head including three different convolution neural networks (CNNs), a first of the three different CNNs configured to generate a repeatability score map, a second of the three different CNNs configured to generate an importance score map, and a third of the three different CNNs configured to generate a static score map.

18. The computer-implemented method of claim 10, further comprising computing a self-supervision loss, a pose estimation loss, and a dynamic region penalization loss for the image using the neural network.

19. An autonomous vehicle comprising:
an image sensor;
at least one computing device comprising at least one memory configured to store machine executable instructions, and at least one processor coupled to the at least one memory and configured to execute the machine executable instructions to implement a neural network, wherein the neural network is configured to:
generate, based upon an image captured using the image sensor, a coordinate map;
generate, based upon the image, a feature map;
generate, based upon the image, a score map;
based upon each of the coordinate map, the feature map, and the score map, identify top-k keypoints satisfying a threshold score criterion for each of the coordinate map, the feature map, and the score map;
identify, based on the top-k keypoints corresponding to the coordinate map, coordinates of the top-k keypoints identified of the coordinate map;
identify, based on the top-k keypoints corresponding to the feature map, features of the top-k keypoints identified of the feature map;
identify, based on the top-k keypoints corresponding to the score map, scores of the top-k keypoints identified of the score map; and
based upon the top-k keypoints identified for each of the coordinate map, the feature map, and the score map, identify top-k static keypoints for pose estimation while excluding other static and dynamic keypoints.

20. The autonomous vehicle of claim 19, wherein:
the coordinate map indicates coordinates of the keypoints of the image;
the coordinate map includes x and y coordinates of each keypoint of the keypoints;
the coordinate map has a downsampled height and a downsampled width in comparison to the image;
the feature map indicates features of the keypoints of the image;
the feature map includes 32 dimensions of each keypoint of the keypoints;
the feature map has a downsampled height and a downsampled width in comparison to the image;
the score map indicates importance of the keypoints of the image;
the score map includes one dimension for each keypoint of the keypoints;
the score map has a downsampled height and a downsampled width in comparison to the image;
the neural network is a residual neural network such as ResNet18 and configured to generate dense image features of 512 dimensions and having a downsampled height and a downsampled width in comparison to the image;
the coordinate map is generated from the dense image features using a coordinate head including a first convolution neural network (CNN);
the feature map is generated from the dense image features using a feature head including a second CNN;
the score map is generated from the dense image features using a score head including three different CNNs, a first of the three different CNNs configured to generate a repeatability score map, a second of the three different CNNs configured to generate an importance score map, and a third of the three different CNNs configured to generate a static score map; and
the neural network is further configured to compute a self-supervision loss, a pose estimation loss, and a dynamic region penalization loss for the image.
